(19) United States
(12) Patent Application Publication
(10) Pub. No.: US 2005/0004882 A1
(43) Pub. Date: Jan. 6, 2005

(54) Method and device for processing mail

(76) Inventors: Volkmar Teichgraber, Furth (DE); Gerhard Israel, Griesheim (DE); Jorg Hemmerling, St. Ingbert (DE); Bernd Grupe, Gross-Zimmern (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/823,439

(22) Filed: Apr. 13, 2004

Related U.S. Application Data
(63) Continuation of application No. PCT/DE02/03856, filed on Oct. 14, 2002.

(30) Foreign Application Priority Data
Oct. 15, 2001 (DE) 101 50 560.4

(51) Int. Cl. G06F 17/00

(52) U.S. Cl. 705/404; 705/401

(57) ABSTRACT

The invention relates to a method and device for processing mail wherein information located on at least one surface of the mail is detected. Address information determined by means of the information located on the surface of the mail is compared with available address information in a data bank or in a database drawn up therefrom. In querying the data bank or database, the address information thus determined is associated with new address information and the address information established by querying the data bank or database is applied to the mail as new address information.

### CROSS-REFERENCE TO RELATED APPLICATION

This is a continuation of International Application PCT/DE02/03856 filed Oct. 14, 2002, the disclosure of which is incorporated herein by reference.

### BACKGROUND OF THE DISCLOSURE

1. Field of the Disclosure

The disclosure relates to a method for processing mailpieces, and to a device suitable for carrying out the method.

2. Description of Related Technology

WO 98/17405 discloses a method for processing mailpieces with an address block and additional delivery markings are determined from an image of the surface of the mailpiece. Using a system for optical character recognition and optionally a video decoding system, the address is determined and is subsequently compared to valid addresses stored in a database and, if necessary, corrected; the correct address is then applied onto the mailpieces. During the processing, the mailpieces are physically buffered in a delay segment.

WO 00/00300 also discloses a method for processing mailpieces in which address information is determined and compared to address information stored in a database in order to provide the mailpieces with new, if necessary, corrected address information or to provide the mailpieces with an error code, if the correction is not successful.

During processing, the mailpieces lie on a conveying segment.

WO 01/58603 relates to a machine for package mailing with self-service in which mailpieces are dropped off by a customer. The pertinent address information is checked on the basis of addresses stored in a database before final entry of the mailpiece. The mailpieces are then stored in a compartment, whereby the ID number of the compartment is stored in a computer system together with an identification code associated with the mailpiece and with additional information relating to the mailpiece.

U.S. Pat. No. 5,703,783 describes an apparatus for identifying and forwarding incorrectly addressed mailpieces, in which the mailpieces whose address is recognized as no longer being valid after a comparison with addresses stored in a database are provided with an identification number on the basis of which these mailpieces are conveyed for further processing. During this further processing, the previously stored (old) address information is loaded on the basis of the identification code and the new address information is acquired, while the mailpieces are in a delay segment. Then the new address is applied onto the mailpieces.

WO 97/11790 relates to a method for reading information present on a shipment, whereby this information contains the target address and an identification code and the shipment is transported on a conveying segment. In this method, this information is acquired and recognized, the target address is checked on the basis of address information stored in a database and, if necessary, corrected, and all of the information is stored in a database in the form of a uniform shipment report or else applied onto the shipment. If the correct target address cannot be determined automatically, then the generated images with the address information are transmitted via a server to processing stations where the address is read by personnel and the corrected address is entered manually.

The methods corresponding to the state of the art, in which the address information is read in, checked and, if necessary, changed, utilize a delay segment that buffers the mailpieces that are being processed. This entails problems and disadvantages for this method, especially due to the very different processing times that are encountered in certain cases. Thus, for example, mailpieces whose processing takes an extremely long time either delay the entire sequence or else these mailpieces have to be sorted out and sent to a separate handling area.

### SUMMARY OF THE DISCLOSURE

The disclosure provides a method with which simpler and more flexible handling of mailpieces is made possible.

According to the disclosure, this objective is achieved by carrying out a method for processing mailpieces that includes the following steps:
a) detecting information that is present on at least one surface of the mailpieces and applying a machine-readable identification code onto the mailpieces,
b) transmitting the detected information and a pertinent identification code to an interface computer and storing the detected information and the pertinent identification code,
c) accessing the stored data and determining the address information on the basis of the detected and stored information,
d) comparing the detected address information with address information present in a database,
e) associating the detected address information with new address information on the basis of the comparison that has been carried out,
f) transmitting the associated new address information and the pertinent identification code to the interface computer, and
g) detecting the identification code applied onto the mailpieces and applying the new address information onto the mailpieces, whereby the new address information is applied as a function of the identification code.

The disclosure also provides a device for processing mailpieces including the following components:
a) a detection device capable of detecting information that is present on at least one surface of the mailpieces and a printer to apply a machine-readable identification code onto the mailpieces,
b) an interface computer comprising memory for storing the detected information,
c) processing stations comprising a processor capable of accessing the stored detected information and the pertinent stored identification codes, and capable of determining address information on the basis of the stored detected information,
d) a database with address information capable of comparing the detected address information with address information present in the database,
e) a processor programmed to associate the detected address information with new address information on the basis of a comparison of the detected address information with the address information that is present in the database,
f) a transmitter capable of transmitting the new address information and the identification code from the processing stations to the interface computer,
g) a device capable of detecting the identification code applied onto the mailpieces and capable of applying the new address information onto the mailpieces, whereby said means applies the new address information as a function of the identification code.

### BRIEF DESCRIPTION OF THE DRAWINGS

Preferred embodiments reference to the drawings are disclosed below.

The drawings show the following:

FIG. 1 is a schematic diagram of an embodiment of the method that is characterized by local data storage, with the device suitable for this purpose and with the pertinent sequences.

FIG. 2 is a schematic diagram of an embodiment of the method that is characterized by data storage on a server, with the device suitable for this purpose and with the pertinent sequences. The mailpieces are physically present at the processing facility.

FIG. 3 is a schematic diagram of an embodiment of the method that is characterized by data storage on a server and a connection to a sorting installation, with the device suitable for this purpose and with the pertinent sequences. The mailpieces are physically present at the processing facility.

FIG. 4 shows the types of codes preferably used in the method.

### DETAILED DESCRIPTION

An example of the application of the correct address information according to the disclosed method is direct printing of the mailpiece. However, it is also possible to first print a medium, for example, a label, and to subsequently apply it onto the mailpiece. The term “address information” is not to be understood in a limiting fashion and especially includes all depictions of data in an optically recognizable and/or machine-readable form that can be used for sorting, transporting or delivering the mailpiece.

In an especially advantageous embodiment of the method, the mailpieces are processed within the scope of a two-stage process, whereby the mailpieces are already completely coded in a source region and undergo preliminary sorting according to target regions in a first sorting step and then undergo fine sorting into smaller units in another sorting procedure.

Moreover, it is advantageous for the new address information to be applied onto the mailpieces in coded form; the address information may be applied onto the mailpiece as a barcode.

A re-addressing process according to the method has advantageous features that will be described in greater detail below.

The disclosure includes all methods for processing mailpieces having defective addresses for domestic delivery that up until now were not machine-readable and that could not be sorted by video coding or manually.

Examples of address deficiencies are:
absent, old or wrong postal code
incorrectly written city or street name
old city or street name
absent or wrong post office box
absent street name and/or absent house number
special cases (recipient without concrete city and/or street name and/or post office box).

Especially preferred embodiments of the method use suitable coding by means of a target code (conventional barcode or, for example, four state code) and/or by means of a mechanically printed postal code in plain text or by an appropriate, manually, or mechanically applied label with the address in plain text or in encrypted form to ensure that the mailpieces can be sorted mechanically and thus can be distributed especially effectively in the target region, for example, in that the mailpieces are directed to the correct delivery district, to the correct delivery district group, to the correct post office box cabinet, or to the correct recipient.

If the house number is present, the method allows mechanical sorting of the mailpieces so as to match the actual sequence in which the delivery is made.

The coding, or the labeling, is preceded by an address determination in which the correct postal code, for example, the delivery postal code, the post office box postal code or the (group) bulk recipient postal code is found on the basis of the recognizable address components by means of linked files from the data, including a conversion file (matching old postal codes to post office locations). Moreover, the additional six characters of the actual target code (street code) and optionally two additional characters are detected.

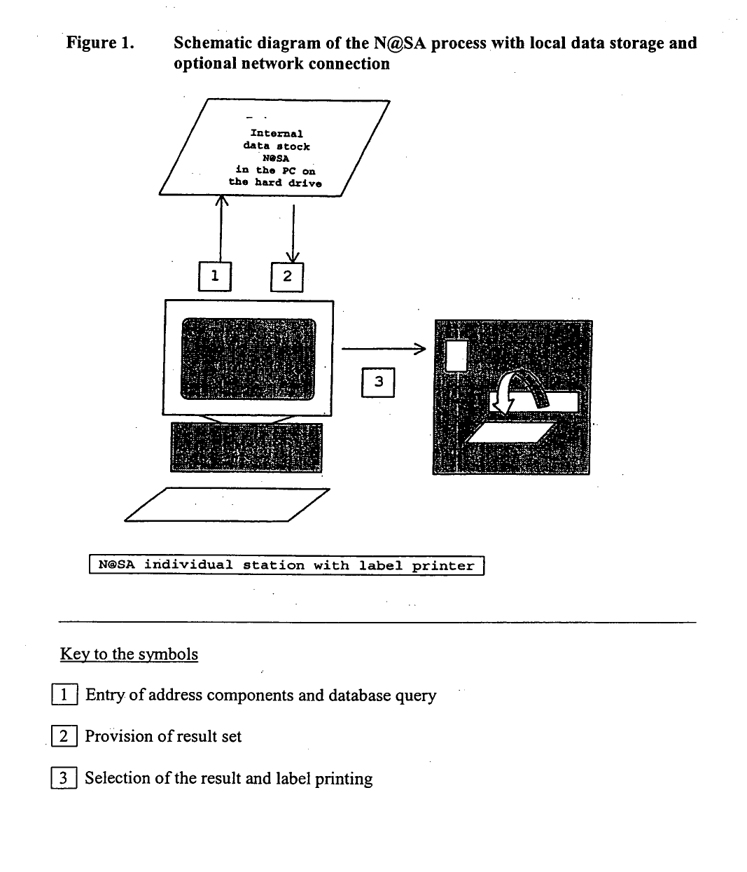

In an embodiment shown in FIG. 1, the processing of physically present mailpieces takes place in a processing station. In this embodiment, address components 1 that are present on the mailpieces are transmitted to an internal data stock. The internal data stock supplies a result address 2 on the basis of the transmitted address components.

Moreover, it is determined whether several addresses were detected. In this case, a selection is made from among the determined addresses.

Preferred process steps for the execution of the method will be explained below. The process steps can be used individually as well as combined with each other, as a result of which the efficiency of the individual process steps is further increased to an especially surprising extent.

A process component that translates into increasing the efficiency of the method with relatively little effort is the implementation of specialized reading software.

A component of this program is a conversion file for converting old addresses into new addresses.

The conversion file, which is incorporated into the so-called dictionary of the sorting installation, can match some of the old postal codes to the currently valid postal codes. In this manner, if the reading quality is sufficient, then the postal destinations are ascertained reliably enough so that the sorting machine is able to sort the mailpieces on the basis of the input distribution information (street, and optionally house number).

The pertinent target code can be applied in different ways, for example, by means of various printing processes. Printing with a fluorescent dye is especially advantageous since this make it possible to especially easily and reliably carry out an optical detection of the target code during a subsequent sorting procedure.

The target code can assume various forms, for example, it can contain the complete address information, which is preferably achieved by using an 11-character to 13-character target code with an additional imprint of the postal code in plain text.

However, it is possible to use another target code instead of this target code, for example, instead of the fluorescent barcode, to use a label with a four state code that likewise contains the requisite target information that is in encrypted form and that is applied onto the mailpiece automatically, preferably in the form of a label. Preferably, the postal code is additionally written on the label in plain text.

In addition to the automated use of the method in processing machines, which are preferably integrated into the normal processing of the mailpieces, individual mailpieces can also be detected separately, for example, at special processing stations.

Preferably, the individual stations consist of a PC with a monitor and keyboard as well as a label printer as an additional output unit that is controlled by the program and that generates a plain text label or, as an alternative, a four state label.

The implementation of the process steps will be explained below with reference to the example of a two-part computer system. However, the disclosure is not restricted to the especially advantageous case of a two-part computer system presented here.

As a matter of principle, any computer is suitable for carrying out the invention.

The term “computer” is not to be understood in a limiting manner, and this can be any unit that is suitable for performing computations, for example, a workstation, a personal computer, a microcomputer, or circuitry suitable for performing computations and/or comparisons.

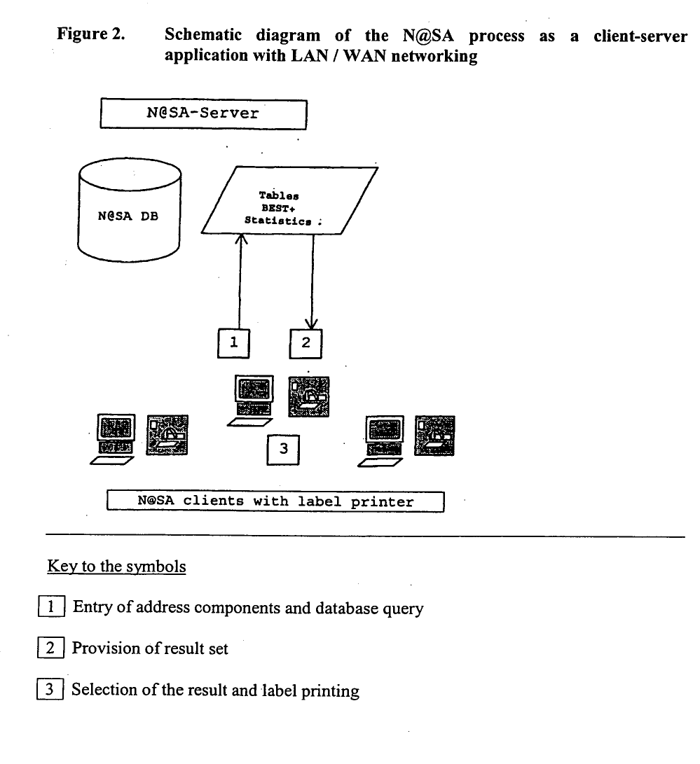

An especially preferred embodiment of the method with client-server implementation is shown in FIG. 2.

With this embodiment, the database is used on a server that takes over the described functions for several processing stations.

This is where the address component 1 is detected, the database is queried, the result data 2 are supplied and the optionally selected result data 3 are provided for a printing process, for example, for printing labels.

The client part is realized in a platform-independent programming language. The use of another programming language is fundamentally possible. The recognizable parts of the address are entered via an input mask. Then a database query is sent by the client to the server.

The server should be a powerful computer with several processors and a large main memory in order to achieve very rapid access times.

The data stock contains the files from a suitable database application containing, for example, postal codes. The design of the database is also configured for rapid access. However, this also means that a great deal of data must be stored redundantly.

The data accesses are provided by a suitable database application, for example, PL/SQL. Via a PL/SQL procedure, the client receives his result set from the server in the form of data records. The result set is sorted at the client and displayed in a selection list. It can be locally limited by additional entries.

A special feature of the program is that, in a separate list, all post office box holders and bulk recipients are automatically displayed with the pertinent data for the delivery (post office box, postal code) if their house address matches the queried data. Moreover, a modified query can be used to access another list of definable recipients.

A decision module or an operator decides which of the displayed data records (from the normal or, for example, from the special selection list) are applicable in each case. The decision module or the operator selects this data record and actuates the printing button. Via the locally connected label printer, the appropriate label is printed with the correct address and glued onto the mailpiece. A decision module is a program module that can observe its environment and that can act largely autonomously. For this purpose, the decision module contains information about the parameters and action instructions that have to be taken into account regarding the procedures. Preferably, the decision module is capable of acting as autonomously as possible.

Then the mailpiece can once again be returned to the normal flow of outgoing mailpieces. The mailpiece is machine-readable up to and including the mechanical sorting for the delivery sequence in the delivery service center.

Additional special features of the NASA individual stations are:
automatic creation of statistical records including the detection of the effective processing time, compression of the statistical records and log output
simple operating interface optimized for the application purpose
connection of the stations via the postal service network.

Instead of physically present mailpieces, it is also possible to process address that are present in electronic form.

Thus, for example, via the machine stations, machine-readable mailpieces can be processed that are to be distributed by means of a sorting installation, preferably the standard sorting installation. The client program is the same as with the individual stations. The INI file controls which mode is loaded. The input mask differs in the two modules. Since the mailpieces are not physically present in the machine stations, in addition to the input mask, the images of the mailpieces are displayed on the monitor.

In order to display the mailpiece images on the mask, a connection to the sorting installation should be established via the in-house network or via the postal service network.

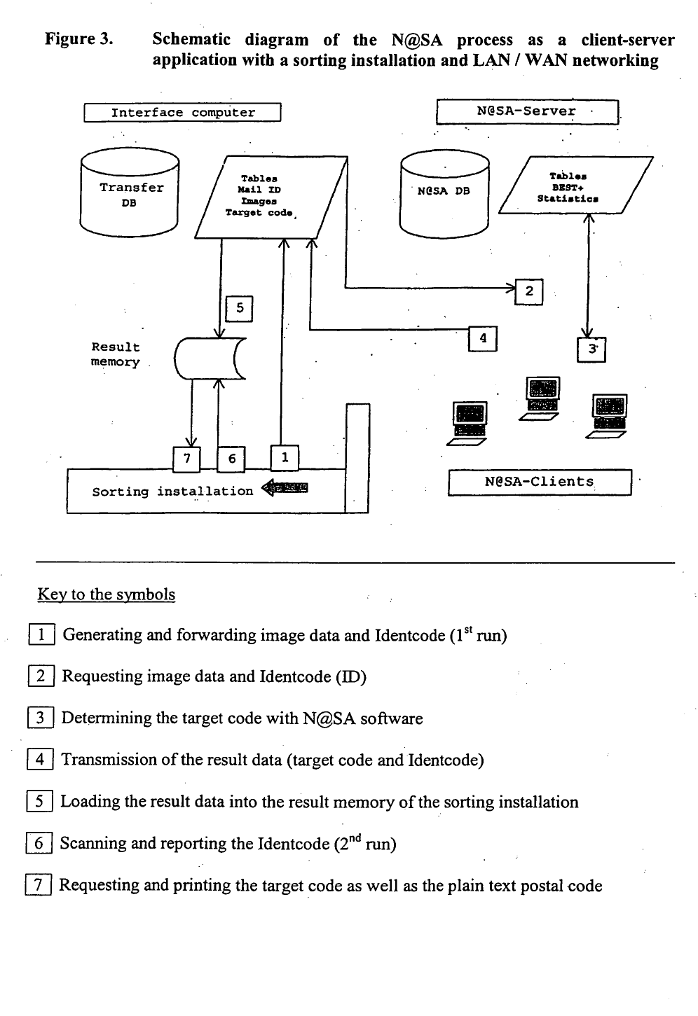

A suitable device for this purpose is shown by way of an example in FIG. 3. This figure shows the use of the method in a mail center. Although all of the embodiments of the disclosed method are suitable for use in mail centers and for bulk processing of mailpieces, this embodiment is especially preferred for the bulk processing of mailpieces.

In this embodiment, the information 1 present on the mailpiece is detected and transmitted to an interface computer. The interface computer contains memory locations for associating the detected mailpiece images.

The interface computer is connected to a server. The server preferably has the previously presented structure and allows a matching of corrected address information on the basis of the information present on the surface of the mailpieces.

The target code 3 is detected on the basis of the ascertained image data and by undertaking a database query, or else a data stock query. These queries are made in the form of automated process steps.

The ascertained result data 4 with the corrected address information are subsequently transmitted to the interface computer.

The interface computer is connected directly or indirectly to the sorting installation.

In the depicted case, the interface computer transmits the result data to a result memory 5 of the sorting installation.

The mailpieces are preferably associated with the corrected address information by detecting an identification code 6 that identifies the mailpiece. Preferably, the identification code 6 was applied onto the mailpiece in order to allow an association of the new address with the correct mailpiece. The identification code 6 makes it possible to associate each of the mailpieces with the pertinent new address information. In an especially preferred embodiment, this is done in that identification codes 6 printed on the mailpieces are detected, and in that the detected identification codes 6 are compared to stored information that is part of the address information via the identification codes 6, and in that the mailpieces are identified on the basis of this comparison. The identified mailpieces are subsequently printed with at least one of the new address information and a code containing the address information. The printing can be done directly onto the mailpiece or else by printing a label that is subsequently affixed onto the mailpiece. The new address information preferably contains a postal code for the further sorting of the mailpiece.

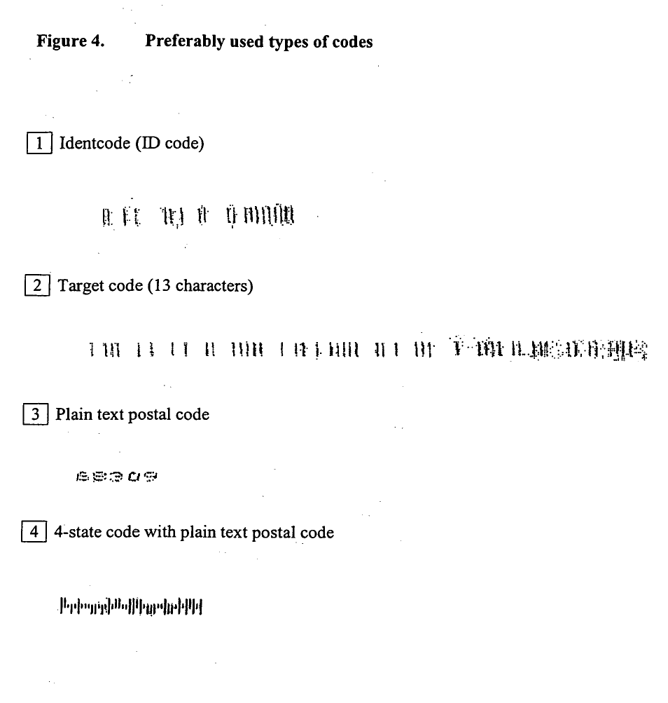

It is advantageous to provide the identification code with a smaller data capacity than the target code, since the identification codes are preferably used only for a temporary processing of the mailpieces. Such an identification code is depicted in a partial image 1 of FIG. 4.

A partial image 2 of FIG. 4 shows an example of a target code used. The depicted target code is thirteen characters long. However, it is also possible to use a target code with a different data capacity, for example, by using an eleven-character target code. The number of characters of the target code is not of the essence for carrying out the method. For example, it is also possible to use a shorter target code that only contains individual information that is needed for further processing the mailpieces, especially for sorting and/or distributing them.

In addition to the fundamentally preferred automatic processing of the mailpieces, it is advantageous for individual items of the new corrected address information also to be printed onto the mailpieces in plain text in order to enable manual processing, for example, in case of an emergency. In the depicted embodiment, the postal code is printed in plain text that can be recognized by an operator as well as read by an automatic reading device. Such a plain text depiction of a postal code can be found in a partial image 3 of FIG. 4.

Another embodiment of an address code is shown in a partial image 4 of FIG. 4. This embodiment is a four-state code with a plain text depiction of the postal code.

The depicted embodiments of address codes are only to be understood by way of an example and can be adapted to the particular requirements of mail shipping and mail processing service providers by experts in the realm of processing mailpieces. The depicted embodiments are especially well-suited for bulk, fully automated processing of mailpieces in large mail shipping companies.

Using the device presented, the method can preferably be carried out as follows:
The images of mailpieces that have not been completely processed are recorded by the sorting installation and the mailpieces are provided with an Identcode (ID-code). Then the mailpieces are stacked and prepared for a second run.
The mailpiece images (e.g. in the TIF format) and the ID-code are transmitted by the sorting installation to an interface computer. The NASA client also accesses this interface computer. Via a suitable database routine, for example, a PL/SQL procedure, the oldest mailpiece image with the accompanying image data and the appertaining ID-code are offered to the client. The image is displayed in the mask.
The decision module or the determination employee now attempts to determine the correct address. This is done analogously to the individual station method. Once the correct address has been determined, then the ID-code is transmitted back to the interface computer with the appertaining target code.
The determined mailpieces are placed into the sorting installation in a second run. Here, the ID-code is read, and the appertaining target code as well as the postal code are applied onto the mailpiece in plain text. Then the mailpiece is machine-readable up to and including the mechanical sorting for the delivery sequence in the delivery service center.

Moreover, it is advantageous to also integrate the functions described below into the processing sequence in order to further increase the efficiency of the processing: zoom function for better recognition of, for example, the address; rotation of upside-down mailpiece images on the monitor by 180 degrees; generation of a fictive target code for mailpieces abroad or other mailpieces that are to be distributed into special compartments of the sorting installation; generation of an additional identification for mailpieces with special mail services or for suffixes of house numbers; monitor display of the mailpieces that are still to be processed; connection of the stations via postal service network; and automatic creation of statistical records including the detection of the effective processing time, compression of the statistical records and log output.

The use in differently configured workplaces, for example, with a PC or with a terminal of a mainframe computer, can be implemented correspondingly, whereby the selection in each case is done as a function of the available computing capacity and can be adapted to the specific requirements.

Centralized solutions have the advantage that the data only has to be made available at a few places and therefore can be updated more easily. However, this prolongs the processing time of the individual steps.

In contrast, processing on the basis of locally stored data allows an increase in the data processing speed. Thus, with the individual stations—as an alternative to the client-server application—an application is effectuated in which the data stock is stored as a quasi database on the hard drive.

There are no limitations in selecting the particular computer systems to be used, since the invention is realized independently of the computer system used in an individual case.

The depictions on the details of the data processing are to be understood by way of an example and can be applied without restrictions to other data processing systems.

1. A method for processing mailpieces comprising:
(a) detecting information present on at least one surface of a mailpiece and applying a machine-readable identification code onto the mailpieces;
(b) transmitting the detected information and the identification code to an interface computer;
(c) storing the detected information and the pertinent identification code as data;
(d) accessing the stored data;
(e) determining address information on the basis of the detected and stored information;
(f) comparing the detected address information with address information present in a database;
(g) associating the detected address information with new address information on the basis of the comparison that has been carried out;
(h) transmitting the associated new address information and the identification code to the interface computer;
(i) detecting the identification code applied onto the mailpieces; and,
(j) applying the new address information onto the mailpiece, whereby the new address information is applied as a function of the identification code.

2. The method of claim 1, further comprising processing the mailpieces according to a two-stage process, comprising preliminarily sorting the mailpieces in a first sorting step and, separately, sorting the mailpieces into smaller units in a second sorting step, and detecting the information present on the surface of the mailpiece and converting the address information present on the mailpiece into the new address information during the first sorting step.

3. The method of claim 1, further comprising ascertaining whether the detected address information contains a first postal code, and converting the first postal code into a postal code that matches correct address information.

4. The method of claim 1 further comprising applying the new address information onto the mailpiece in coded form.

5. The method of claim 4, wherein the address information comprises a barcode.

6. The method of claim 4, wherein the address information at least partially in plain text.

7. The method of claim 2, further comprising carrying out at least one sorting step as a function of the new address information.

8. The method of claim 1, further comprising transporting the mailpieces at least over a segment as a function of the new address information.

9. A device for processing mailpieces comprising:
a) a detection device capable of detecting information present on at least one surface of the mailpieces and a printer to apply a machine-readable identification code onto the mailpieces;
b) an interface computer comprising memory for storing the detected information;
c) processing stations comprising a processor capable of accessing the stored detected information and the appertaining stored identification codes, and capable of determining address information on the basis of the stored detected information;
d) a database comprising address information and a comparison unit adapted to compare the detected address information with address information present in the database,
e) a processor programmed to associate the detected address information with new address information on the basis of a comparison of the detected address information with the address information that is present in the database;
f) a transmitter capable of transmitting the new address information and the identification code from the processing stations to the interface computer; and,
g) a device capable of detecting the identification code applied onto the mailpieces and capable of applying the new address information onto the mailpiece as a function of the identification code.
